(19) United States
(12) Patent Application Publication
(10) Pub. No.: US 2023/0113574 A1
(43) Pub. Date: Apr. 13, 2023

(54) MATCHING CANDIDATES TO ORGANIZATION POSITION

(71) Applicant: STRATEGIC MANAGEMENT DECISIONS, LLC, Atlanta, GA (US)

(72) Inventors: Scott Mondore, Atlanta, GA (US); Shane Douthitt, Parrish, FL (US); Matt Betts, Roswell, GA (US); Hanna Spell, Atlanta, GA (US); Pat Turbiville, Pensacola, FL (US)

(21) Appl. No.: 17/624,547

(22) PCT Filed: Jul. 1, 2020
(86) PCT No.: PCT/US20/40555

§ 371 Date: Jan. 3, 2022

Related U.S. Application Data
(60) Provisional application No. 62/869,355, filed on Jul. 1, 2019.

(51) Int. Cl. G06Q 10/1053; G06Q 30/0203

(52) U.S. Cl. CPC G06Q 10/1053; G06Q 30/0203; G09B 5/065

(57) ABSTRACT

This disclosure is directed to a computer-based data driven approach of assessing a job candidate to a job. A matching algorithm takes candidate assessment data and employee survey data profiles and evaluates the level of match between the two sets of data. The computer based matching algorithm takes into consideration differential weighting on scores that best predict future turnover. The higher the match, the better the fit of the candidate. The computerized analysis is automated and populates on on-line platform that is linked to an applicant tracking system related to a user organization (e.g. a company or non-profit) to populate the open jobs for which candidates are able to view and apply.

### CROSS REFERENCE TO PRIOR APPLICATIONS

This application claims priority to U.S. provisional patent application 62/869,355, the entirety of which, including all appendices, is incorporated herein by reference in its entirety.

### FIELD

This disclosure is directed to a system, methods, and apparatus for matching employment candidates to organizational positions and structural organization reporting positioning within organizations, including video training options.

### BACKGROUND

Employee assessments and surveys are commonly used to gather information on employee performance, views on the employer, and/or other information. These surveys typically include similar features and benefits, such as data reporting, benchmark data reporting, and generic action planning tools. These data are typically used for evaluation of supervisors and their employees, to gauge the satisfaction and performance of current employees, and other tasks relating to the improving the function of an organization with its existing employees. Thus far, however, the use of such data outside of the context of evaluating current employee, specifically, the association of such data with real business outcomes, has been missing from the art.

### SUMMARY

In one aspect, this disclosure describes a system for collecting data regarding the attitudes and opinions of existing organizational employees. The data may be collected, for example, through employee satisfaction surveys administered through an internal human resources information system (HRIS) facility, or an outside vendor. The employee surveys elicit responses from employees to questions that may be categorized into one or more broad categories, such as questions relating to supervisor style, the importance of training for skills improvement, etc. In certain aspects employee survey questions are non-boolean, and ask the employee to rank on a scale (e.g., from 1 to 5), the importance of some feature of their workplace experience. Questions provided in employee surveys are generally directed to gauging employee satisfaction with various aspects of the employee's work experience, and a higher numerical response score on a given question generally indicates a higher degree of satisfaction.

In certain embodiments, survey data from existing employees is collected and sorted into one or more categories. Exemplary categories may correspond to a location, a supervisor, or a roll or type of job. For example, employee responses for all employees who work in a given location may be gathered into that location's profile, employee responses for all employees who work for a given supervisor may be gathered into a profile associated with that supervisor, all the employee responses for a given type of job or roll may be gathered into a corresponding profile, etc. It will be noted here that an individual employee's response data may be present in more than one category or profile.

In certain embodiments, within each profile, an average is generated of the individual survey results. In certain embodiments, this average is weighted in favor of responses from employees with more longevity. For example, if the survey includes the question, “How important to you is the opportunity for training to advance your skills”, all employee responses to this question within a given location (e.g., Bakersfield) are averaged to result in a composite score reflecting the average response for all Bakersfield employees to that question, but the average is weighted in favor of responses for employees with more years of service. In certain embodiments, outlier employee data, e.g., employees with very short terms of service, are dropped from the weighted average data altogether before further processing. In another embodiment, individual employee scores are simply averaged, generating an array of answers that may be thought of as typical of the average employee within the profile, rather than typical of the average long-standing profile.

In certain embodiments, the composite (i.e., average or weighted average) score for each answer is then recoded or mapped to a different numerical value. This is done in instances where it is desirable to remap the average score to one of a small number of score bands, for example, where variance in the raw data resulting in the average score is does not vary to a large degree.

In certain embodiments, data relating to each question and answer pair, and the responses in particular, is analyzed to determine the correlation or importance of the response to some condition of employment, for example, employee retention or longevity. In one embodiment, regression analysis is performed on survey data from existing employees to determine the extent to certain responses on certain questions correlate with employee retention. Thresholds may be applied to determine the most important, or most highly correlated question-answer pairs, which may then be selected for further use and analysis, while question-answer pairs may be discarded. In other embodiments, all question-answer pairs are retained, but an array of weights is generated that reflects the degree of correlation

for each question. These correlations may be cross checked or validated against preexisting or contemporaneously generated data for other existing employees. The goal of this step is to determine which questions are eliciting responses that are most highly correlated to employee retention (e.g., why do employees stay?), and whether the correlation is positive or negative. Thus, correlation steps seek to determine both the magnitude and sign of the correlation of a given question's response to employee retention.

In certain embodiments, response data may be aggregated, either before or after weighting, according to subject matter. For example, if there are multiple questions within a survey that relate to a common theme (e.g., “communication” or “recognition”, responses for all questions within that category may be aggregated (e.g., by averaging, or weighted averaging) into a category reflecting the theme.

In some embodiments, the averaged answers within a profile are compared to answers on similar questions supplied by an employment candidate. This may be preceded by recoding numerical responses on a candidate survey in the same manner applied to the averaged employee survey data. In one embodiment, the comparison is achieved by differencing, on a question-by-question basis, the recoded candidate response with the averaged employee response to the corresponding question.

In certain embodiments, the difference scores are remapped to a “match” score that indicates the similarity of the candidate's responses to the typical employee in the profile. Such embodiments may then sum the match score across the entire array of questions to generate a “match score” for a given profile, and these profile level “match scores” may then be summed to create an overall match score. As part of this process, data from the regression analysis can be used to increase the weight of “matches” on particularly important issues or themes. These match scores provide a hiring manager or other human resources personnel with the ability to view, at a glance, whether a candidate, or a group of candidates, match culturally with existing, long-standing employees in a given location or who work for a given supervisor.

Additional features and advantages of the inventive embodiments will be clear upon review of the following detailed description.

### BRIEF DESCRIPTION OF THE DRAWINGS

Aspects of the disclosure will be better understood after reading the following description when considered with the drawings in which:

FIG. 1 is a conceptual block diagram illustrating an example of a hardware implementation for an online computer system 100, constructed according to the principles;

FIG. 2 is an example flow diagram of a method of building longevity profiles performed according to principles of the disclosure;

FIG. 3 is an example flow diagram of assessing a candidate match to a longevity profile, performed according to principles of the disclosure;

FIG. 4 is an illustration 400 of the types of topics making up the candidate assessment survey, in accordance with principles of the disclosure;

FIG. 5 is an illustration of a job posting page that may be generated by system TOO and made available on-line for candidate viewing, according to principles of the disclosure;

FIG. 6 is an illustration of a candidate assessment page 600 showing results and score of candidates for a particular open position, in accordance with principles of the disclosure;

FIGS. 7A-7C are illustrations of a mobile device, such as, e.g., a smart phone (but could be any type of computing device) that may be used by a candidate to initiate and respond to the candidate survey provided to a particular candidate who responds to a job posting, in accordance with principles of the disclosure; and

FIG. 8 is an illustration of a report 800 for a particular candidate, in accordance with principles of the disclosure.

FIG. 9 is an exemplary focused interview template that may be provided to an interviewer in accordance with principles of the disclosure.

### DETAILED DESCRIPTION OF THE PREFERRED EMBODIMENTS

Embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

This disclosure is directed to a computer-based data driven approach of assessing a job candidate to a j ob. Current employee survey data is captured (e.g., opinions and characteristics related to work-life balance, management, career development, pay, peer relations, and the like) to populate different types of profiles. Exemplary profiles may include one profile for a hiring manager, one profile for a geographic location, and a profile for the role (i.e., the type of job opening/position). A candidate applying for a job opening takes a brief assessment that requests feedback on the importance of certain aspects of the job to them. These aspects are parallel to or are substantially the same as the aspects that are assessed in the employee survey. The candidate assessment system activates a connection between the candidate's assessment and the corresponding hiring manager (or other similar responsible person) employee survey results.

A matching algorithm takes the candidate assessment and the employee survey data profiles and evaluates the level of match between the two sets of data. The computer based matching algorithm takes into consideration differential weighting on scores that best predict future turnover. The higher the match, the better the fit of the candidate. The computerized analysis is automated and populates on on-line platform that is linked to an applicant tracking system related to a user organization (e.g. a company or non-profit) to populate the open jobs for which candidates are able to view and apply.

The online platform provides multiple scores to one or more hiring managers based on the matching algorithm to compare candidates to each other and to compare candidates to different job openings. This allows managers to quickly assess who is the best candidate for a particular job and/or which job is best for a particular candidate. Additionally, a ranking of best fits of multiple candidates may be provided. Based on the level of fit between the candidate(s) and the hiring manager(s), an online structured interview guide within the system may be activated so that the hiring manager can ask additional questions to a candidate. Moreover, training sessions for how to use the systems for both hiring managers and the candidates are provided and managed by the online system to guide them in their portion of the process.

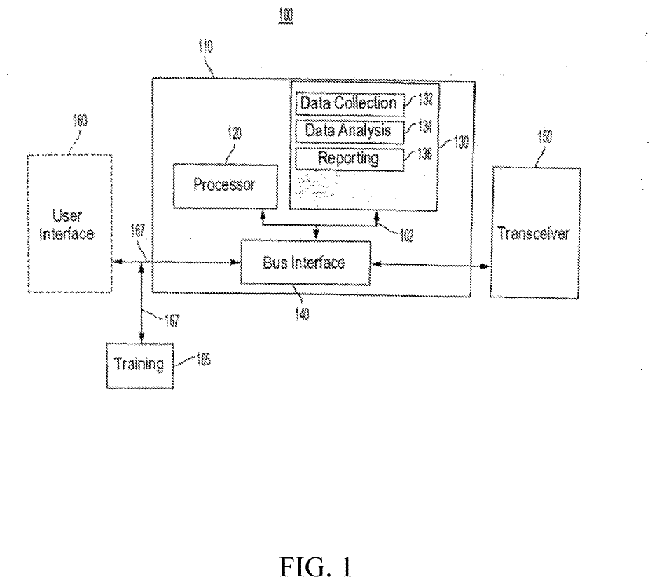

FIG. 1 is a conceptual block diagram illustrating an example of a hardware implementation for an online computer system 100, constructed according to the principles of the disclosure. Other architectures might be suitable, as one of ordinary skill in the art would know. The system 100 includes a processor 120 that may be used to implement the methods described herein, and may be an action planning system for hiring. In this example, the system 100 may be implemented with a bus architecture, represented generally by bus 102. The bus 102 may include any number of interconnecting buses and bridges depending on the specific application of the system 100 and the overall design constraints. The bus links together various circuits including one or more processors, represented generally by processor 120, and computer-readable media, represented generally by computer-readable medium 130. The bus 102 may also link various other circuits such as timing sources, peripherals, voltage regulators, power management circuits, and the like, which are well known in the art, and therefore, will not be described any further. A bus interface 140 provides an interface between the bus 102 and transceiver 150. The transceiver 150 provides a means for communicating with various other apparatus over a transmission medium or communication link, such, e.g., the Internet, or a cell network. Depending upon the nature of computer system 100, a user interface 160 (e.g., keypad, display, speaker, microphone, etc.) may also be provided. The user interface 160 may be associated with, or part of, a mobile user device, such as a tablet computer or cellphone.

The processor 120 may be responsible for managing the bus and general processing, including the execution of software stored on the computer-readable medium 130. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The processor 120 may perform as a server.

A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, or any other suitable medium for storing or transmitting software. The computer readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The functions and methods described herein may be implemented by various modules in computer 100. As used herein, the term “modules” refers to hardware, firmware, a combination of hardware and software, software, or software in execution. By way of example, a module may include a process, an object, an executable, a thread of execution, a program, an application, a routine, a subroutine, a block of code or instructions, or any other software executed by the processor 120 or by another processing device. In this example, these modules may reside in the computer readable medium 130, which represents a single storage device, multiple storage devices, or other media. The software, when executed by the processor 120, causes the processing system 110 to perform various functions described herein. The computer-readable medium 130 may also store data that is manipulated by the processor 120 when executing software.

As depicted in FIG. 1, computer readable medium 130 may store a plurality of computer processing modules, including a data collection module 132, a data analysis module 134, and a reporting module 136, among other modules.

Data collection module 132 may be configured to collect, for example, survey data from employees across an organization or organizations, or candidates that may be applying for a job. In accordance with some aspects of the disclosure, survey results may be grouped, for example, by departments or other divisions within an organization, as described more below. In some aspects of the disclosure, the data collection module 132 may be configured to provide a network-based survey, for example, over the Internet, a Local Area Network (LAN), Personal Area Network (PAN), or any other type of communication network. The survey data may include responses to survey items prepared and/or provided by, for example, employees and/or job candidates.

Data analysis module 134 may be configured to perform various types of analyses on the collected data and to generate and provide, e.g., scores of candidates to a hiring manager, as described more below.

Reporting module 136 may be configured to generate and present one or more reports on the user interface 160 over communication link 167 that graphically and/or textually represent the results of a matching analysis, as described more below.

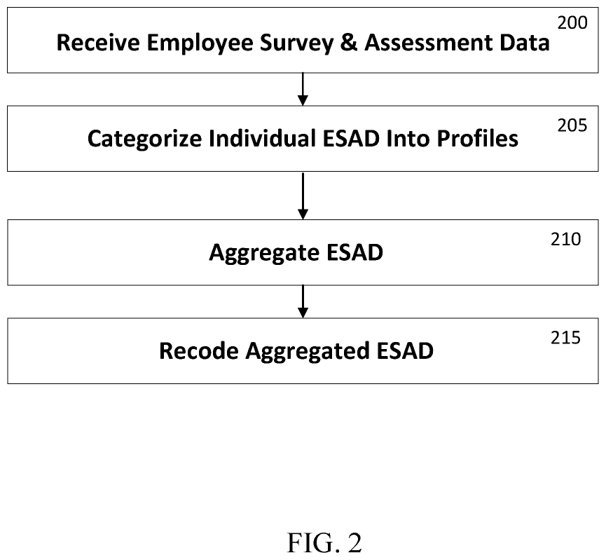

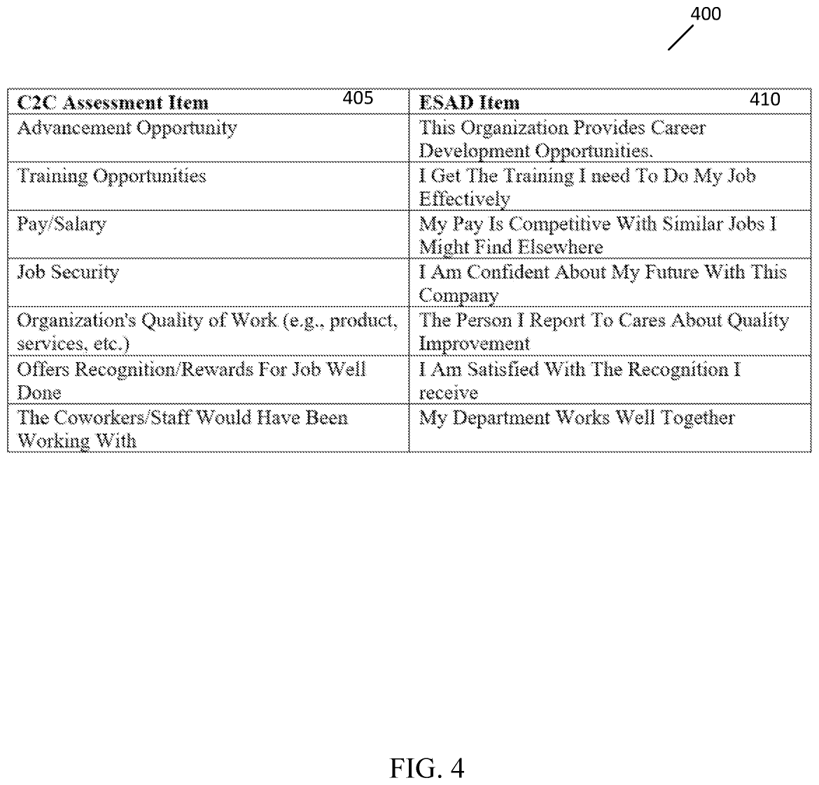

FIG. 2 is an example flow diagram of an online method of generating longevity profiles according to principals of the disclosure. The goal of the method depicted in FIG. 2 is to generate a profile of answers to employee survey questions that is indicative of, and therefore predictive of, employee longevity, i.e., an absence of employee turnover. The method of FIG. 2 assumes the existence of a dataset of Employee Survey and Assessment Data (ESAD), which has been generated by the application of employee satisfaction surveys or the like to existing employees in an organization. At step 200, the online system such as processor 120 receives ESAD. If ESAD has not yet been generated, the online system provides employee surveys to current employees or permits current employees to access and complete the surveys online. Example of the topics that may be included in the survey may be found in relation to FIG. 4 (see, e.g., 415), however, other topics and questions may be included. Completed surveys provide a basis for Employee Survey & Assessment Data, received from one or more current employees.

At step 205, the system 100 categorizes the ESAD into assessment profiles. An assessment profile is a grouping of ESAD responses from individual employees into categories common to those employees. Exemplary profiles may be related to location, manager and role or position. These profiles would include all ESAD from employees working a given location, all ESAD from employees working for a specific supervisor, and all ESAD for employees in a particular job, respectively. Other profiles are possible and within the scope of the inventive embodiments, for example, time of shift (1st shift, 2nd shift, etc.), product or service line on which the employees work, demographic characteristics of the employee, etc. Any variable common to a group of employees may be used as the basis for a profile. Again, the goal of the system of FIG. 2 is to build a longevity profile for employees within some category. The category may be defined arbitrarily.

At step 210, the ESAD answers are aggregated for each ESAD question across all employees in the profile. An example showing the result of the process steps discussed thus far appears below in Table 1. As can be seen a Table 1, an array aggregated ESAD answers (in this case, the mean of all answers) is compiled for a given location (e.g., Bakersfield), a given supervisor (E.g., Acosta), and a given role (Operations). The rows (the mean ESAD answers) represent a profile for the location, supervisor or role, i.e., answers to the ESAD questions that are typical or representative existing employees within the profile (e.g., at that location).

Scores Pulled from the Employee Survey Cut by Location, Manager and Role Loc (BAKERSFIELD) Sup (ACOSTA, MICHELLE) Role (OPS)

TABLE 1

| Level | WLB_1_mean | SrLeaders2_mean | SrLeader3_mean | CareerDev2_mean | CareerDev3_mean |
|---|---|---|---|---|---|
| Loc | 4.40 | 4.07 | 4.27 | 4.23 | 3.87 |
| (BAKERSFIELD) | 3.91 | 3.79 | 3.74 | 3.76 | 3.97 |
| Sup (ACOSTA, | 3 | 1 | 2 | 3 | 3 |
| MICHELLE) | | | | | |
| Role (OPS) | | | | | |

Additional aggregating steps may occur as part of or prior to step 210. For example, the columns in Table 1 above represent means for individual ESAD answers, but this is not a requirement. ESAD answers may be grouped according to theme or subject matter (e.g., communication, training opportunities, compensation), either before or after aggregation. For example, individual answers pertaining to a general subject matter area may be averaged to generate a profile having a columns corresponding to the general subject matter of questions rather than individual answers.

At step 215, the system 100 recodes the aggregated ESAD into five different bands (1-5). Each profile (i.e., location, manager, role) has data aggregated into bands (low to high) to match against candidate assessment, which will be similarly recoded to simplify a comparison of the two data sets. Table 2, below shows exemplary cut values for recoding, and Table 3 shows an exemplary table of recoded data (e.g., the data of Table 1) applying the cut values of Table 2.

### Cut Value Scale:

TABLE 2

| 5 | 4 | 3 | 2 | 1 |
|---|---|---|---|---|
| 5.00 to | 4.18 to | 3.96 to | 3.75 to | 3.53 to |
| 4.18 | 3.97 | 3.75 | 3.53 | 1.00 |

### This is the Location, Supervisor, and Role Scores Recoded Based on the Cut Values

TABLE 3

| WLB_1_mean | SrLeaders2_mean | SrLeader3_mean | CareerDev2_mean | CareerDev3_mean |
|---|---|---|---|---|
| 5 | 4 | 5 | 5 | 3 |
| 3 | 3 | 2 | 3 | 4 |
| 3 | 1 | 2 | 3 | 3 |

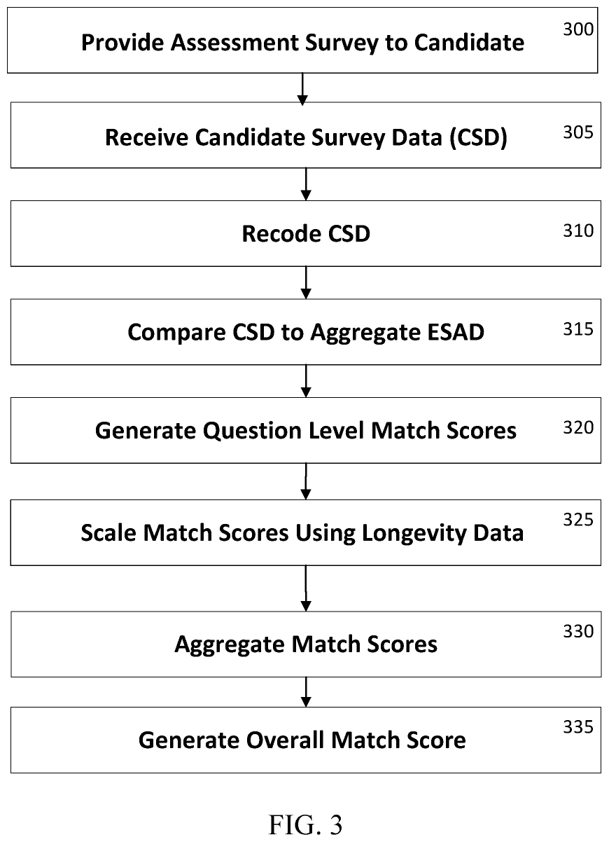

FIG. 2 and FIG. 3, and any other flow diagrams herein, may also represent a block diagram of the software modules required to perform 1 the corresponding step when loaded into readable memory and executed by a computer, such as processor 120. These modules may execute on a computer platform such as that illustrated in FIG. 1, and may produce the information and outputs such as illustrated in FIGS. 4-8, and to receive user input.

FIG. 3 is an example flow diagram of a method of assessing an employment candidate's match to a longevity profile, performed according to principles of the disclosure. At step 300, a candidate survey is provided to the employment candidate. The survey is designed to elicit information that is similar to the information elicited by an employment satisfaction survey administered to existing employees. Exemplary survey topics are shown at 410 of FIG. 4, which also shows the correspondence between questions asked of candidates and similar questions asked of existing employees. The candidate assessment survey may be provided by online system 100 in response to an applicant responding to an open job posting. At step 305, the system 100 receives the completed assessment, or candidate survey data (CSD). At step 310, the system recodes the candidate's responses using the same cut values used at step 220 to recode the corresponding responses in the processed ESAD data. A table showing an example of recoded candidate responses appears below at Table 4.

TABLE 4

| | | | Job | | |
|---|---|---|---|---|---|
| | | Communication | Security | | |
| | | Senior | Financial | | |
| | WLB | Leadership | Security | Training | Learning |
| Candidate | 3 | 4 | 3 | 3 | 4 |
| Score | | | | | |

It will be noted that the categories listed in table 4 are not identical to those in corresponding table 3. This is because, in some embodiments, there is not word-for-word correspondence between the questions provided in surveys for existing employees and those provided for employment candidates, although the questions may roughly correspond, as is shown in Table 4. Accordingly, in some embodiments, candidate questions are organized according to a theme corresponding to the ESAD question, which is shown in table 4. In alternative embodiments, where the individual existing employee questions are aggregated into themes, those themes may correspond to questions posed to candidates, and vice versa. For example, an employee survey may contain individual questions asking an employee state the importance of communication with their immediate supervisor, but also with other more senior organizational leaders. These specific questions fall under the general rubric of “communications”, or “communications with superiors”, and so these answers may be aggregated under the method described in reference to FIG. 2. A candidate, however, may only be asked “how important is communication with your superiors?”, and so this response will be compared to the aggregated “communication” ESAD data. Thus, in certain embodiments, specific candidate responses are compared to employee response data for specific responses, or for themes, and in other embodiments, candidate response themes are compared to specific employee responses, or for themes.

Returning again to FIG. 3, at step 315, the received assessment triggers a matching process that includes executing a software algorithm by processor 120 for analyzing the assessment that matches the job candidate assessment data with organization survey data developed based on employee surveys such as processed in relation to FIG. 2. The algorithm compares the recoded CSD to the aggregated and recoded, aggregated ESAD to generate comparison data. In certain embodiments, this comparison process involves differencing the recoded CSD data and the recoded, aggregated ESAD, for each response and in each of the categories of processed ESAD (location, supervisor and role). An example of output from this process appears below as Table 5, which shows the differences for the values in Tables 3 and 4, above, for each of 5 questions/themes and each of 3 profiles (location, supervisor, role). The comparison data shown in Table 5 represents how close or far a candidate's answers are to the typical employee responses in a given location, or who work for a given supervisor, or who hold a given job role.

Difference Between the Candidate Score and the Levels of Employee Survey Data {Loc, Sup, Role)

TABLE 5

| | | | | | |
|---|---|---|---|---|---|
| Loc-Candidate | −2 | 0 | −2 | −2 | 1 |
| Sup-Candidate | 0 | 1 | 1 | 0 | 0 |
| Role-Candidate | 0 | 3 | 1 | 0 | 1 |

It will be noted that the difference between a candidate's answer data and the processed ESAD data may be either positive or negative for each question, but difference in either direction indicates a mismatch between the candidate's attitudes and those of existing employees. Accordingly, in some embodiments, the difference data set forth above in Table 5 is remapped to a match score (Step 320) to eliminate the negative numbers and to represent a match with higher numbers. In one embodiment, 0 (perfect match) is mapped to 3, +/−1 and +/−2 (indicating some mismatch) is mapped to 2 and +/−3 and +/−4 (indicating more severe mismatch) is mapped to 1.

In step 325 the match scores are scaled to increase the weight of matches on ESAD questions that are highly correlated with employee longevity. According to inventive systems, a regression analysis is performed on individual ESAD questions against the employee's time of service, to determine the strength of the correlation between individual answers and longevity. In certain embodiments, the overall correlation between a response and longevity is compiled by aggregating (e.g., averaging) correlations for all employees. That aggregated correlation is then used to scale the matching score at comparison step 325. For questions that are highly positively correlated with longevity, the match score is increased, for questions that are weekly correlated with longevity, the match score is relatively unchanged, for questions that are highly negatively correlated with longevity, the match score is made negative. The strength of the correlation for a given ESAD question may differ depending on what profile is being considered (location, supervisor or role). The result of this process is set forth below in Table 6.

Grid of the Candidate's Fit with the Data:

TABLE 6

| | | | Job | | |
|---|---|---|---|---|---|
| | WLB | Communication | Security | Training | Learning |
| Loc Fit | 2 | 4.5 | 2 | 2 | 1 |
| Sup Fit | 3 | 1.5 | 1 | 3 | 3 |
| Role Fit | 3 | −1.5 | 1 | 3 | 1 |

Taking the third column of the tables above (for the second question), Table 1 shows that the aggregate answer for employees at a given location (Bakersfield) weighted according to longevity is 4.07. Under a method described herein, that is recoded to 4 (Table 3). When asked a similar question (i.e., one related to financial security), a job candidate provides an answer that recodes to 4 (Table 4). This is an exact match to the existing employee data for that location, so difference value is zero, which is mapped to the value 3. However, in the examples set forth above, this question is highly correlated to longevity at this location, so an additional scale factor is applied reflecting the importance of this question, and it is assigned a value of 4.5. This result reflects a match on a question strongly correlated with longevity at this location. The third row under the same question/theme (Communication) indicates a slight mismatch on a question negatively correlated with longevity for this role.

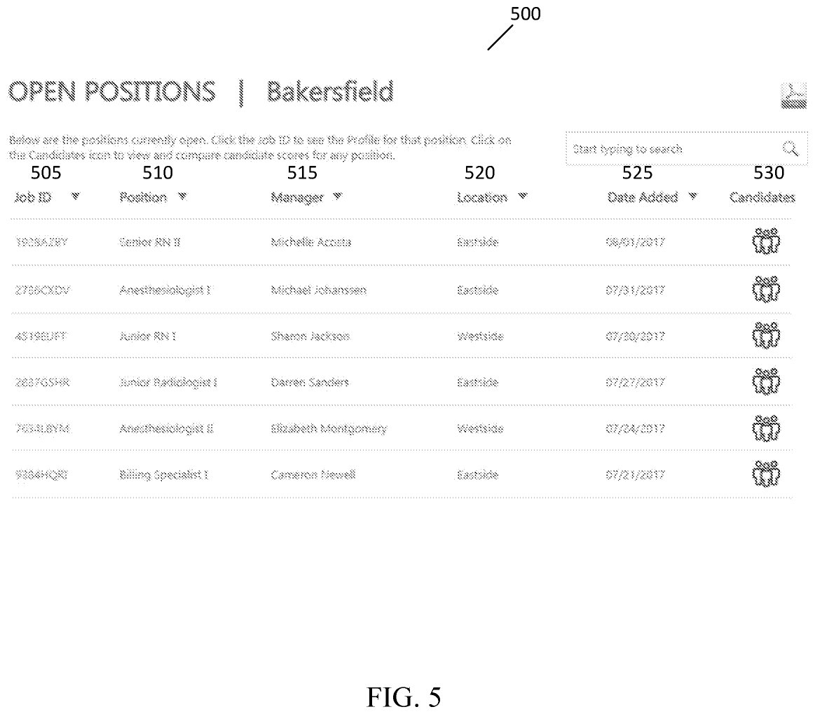

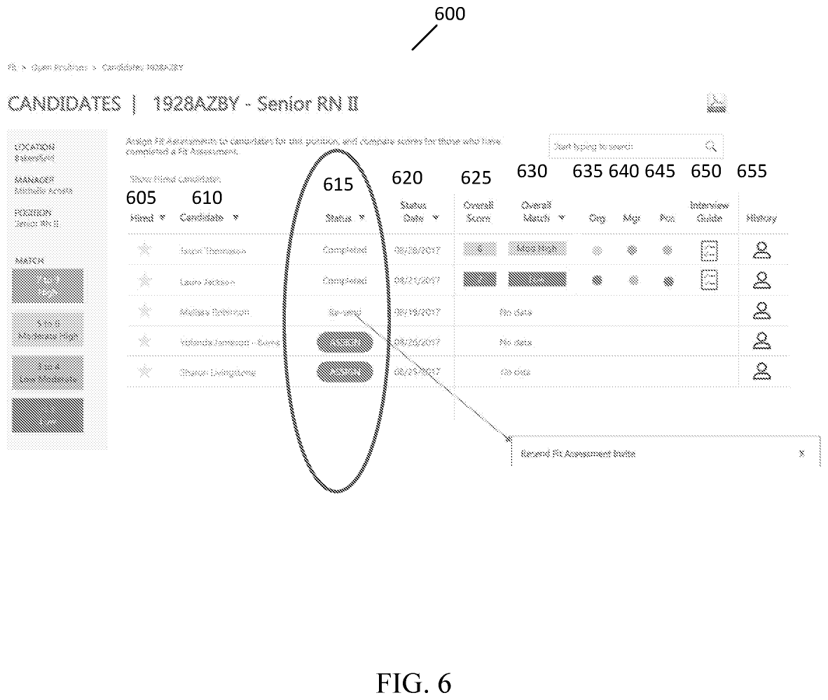

Referring still to FIG. 3, the method then generates an aggregate match score. This may be done in two stages. First, an aggregate match score for the subject location may be generated by summing the individual match scores per question. Additionally or alternatively, the match scores for the three profiles (e.g., location, role, supervisor) are summed to generate an overall match score for the position at a whole. In all cases, the higher the score, the better the match to the longevity profile. It will be noted, then, that methods described herein may produce multiple match scores (i.e., overall match, manager match, role match and location match) such as shown in the examples of FIGS. 5 and 6. Subsequent to their generation, the scores are provided to a user of the system 100, which is typically a responsible person of an organization such as, e.g., a company or non-profit. Additionally, the system may identify training for any user of the system for any of the steps in FIGS. 2 and 3 in order for the user to properly understand the steps and data being requested and relied upon. This training may include a video training segment for any or all of the steps of FIG. 2 or FIG. 3. The video training may be controlled and initiated by processor 120 with the training request and controls conveyed over a communications link 167 to a training module 165 for viewing by a user of system 100 on a user interface 160. The user interface 160 may be, e.g., a computer screen, a laptop display or a mobile device display such as, e.g., a cell phone.

FIG. 4 is an illustration 400 of the types of topics making up the candidate assessment survey, in accordance with principles of the disclosure. As shown in the left-hand column 410 (see, e.g., step 300, FIG. 3) questions are presented that mirrors to a significant degree the questions being asked in current employee survey 415 on the right-hand side 415 (see, e.g., step 200, FIG. 2). The correlation of the topics in each column establishes, at least in part, a basis for prioritizing those topics as having greater importance or lesser importance to an organization and/or a hiring manager, which then can be used to determine a scoring of responses gathered or received from candidates.

FIG. 5 is an illustration of a job posting page 500 that may be generated by system 100 and made available on-line for candidate viewing, according to principles of the disclosure. The open positions are shown as posted by an office related to a location in Bakersfield. Other locations related to an organization or company may have other separate “open positions” page(s) available for viewing by potential applicants. The job posting page in this example includes six jobs with associated job identifiers in column 505, position title shown in column 510, associated manager shown in column 515, the specific location of the open position shown in column 520, date the open position was added is shown in column 525, and a link to begin the application process by candidates in column 530. Although the job postings in this example relate generally to medical positions, the open positions page, depending on the company or entity involved, may alternatively reflect any job field such as engineering, marketing, sales, educational, technical, law enforcement, legal, manufacturing, academics, or the like.

FIG. 6 is an illustration of a candidate assessment page 600 showing results and score of candidates for a particular open position, in accordance with principles of the disclosure. In this example, the page shows results of scoring for candidates that responded and completed a survey for posted position for “Senior RN II,” with Job ID “128AZBY” (shown in FIG. 5). The columns for each candidate 610 in the page 600 include a “hired” indicator 605 that reflects the status of the candidate of either being hired or not, a column showing the candidate's name 610, a status date column 620 showing a date of latest information update per candidate 610, an overall computed score column 625 for each

candidate 625 showing the scoring for each candidate using the survey data from current employees and candidate responses. The scoring of the computed score column 625 may be color coded (red, green, yellow, etc.) for easy recognition by a user. A legend 660 for defining the color-coded scoring may be provided. An “overall match” provides a general matching rating of a candidate for the particular opening (e.g., the “Senior RN II” position). Together the “overall score” 625 in combination of the “overall match” 630, provide a more comprehensive color-coded rating provided for each candidate.

A status column 615 reflects the current status of the processing of a candidate's submission of an application. For example, the application may be “completed” (including scoring completed, including a fit-assessment), a “re-send” indicator indicating an issue with an application that requires additional attention by a candidate, or “assigned” which indicate that an application has been or being assigned for processing which may include being processed by a hiring manager. Columns 635, 640, 645 are color coded indicators per candidate reflecting the scoring based on “organization” 635, “manager” 640, and “position” 645. In this way, a visual indication of the scoring, by these attributes, can be readily discerned by a viewing user by the three categories. An interview. guide link or document 650 may be provided that is tailored for the manager in view of the particular position for each candidate. A link 655 may be made available for a user to view the progress and activity for a particular candidate.

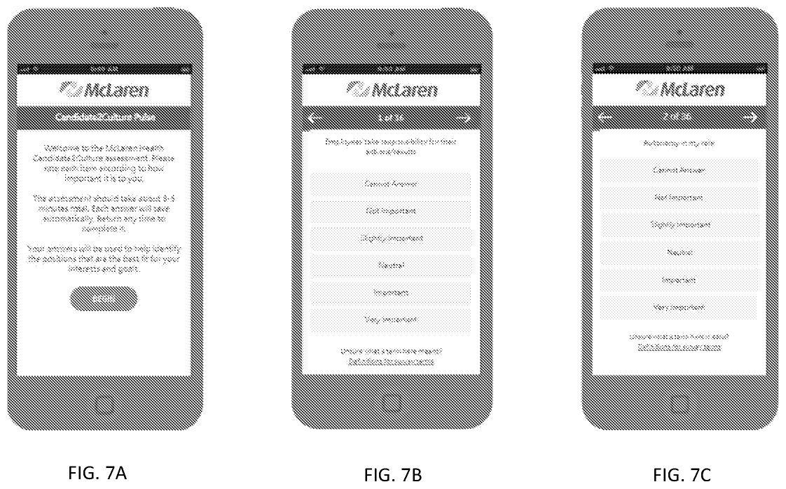

FIGS. 7A-7C are illustrations of a mobile device, such as, e.g., a smart phone (but could be any type of computing device) that may be used by a candidate to initiate and respond to the candidate survey provided to a particular candidate who responds to a job posting, in accordance with principles of the disclosure. The survey questions may be presented in sequence with responses received and record and eventually scored by system 100. A training sequence (e.g., a video) may also be provided to the candidate to explain how to use and respond to the survey. The topics may be organized by subject per screen with a plurality of selections reflecting a level of importance to an applicant. These responses form a basis for computing a score.

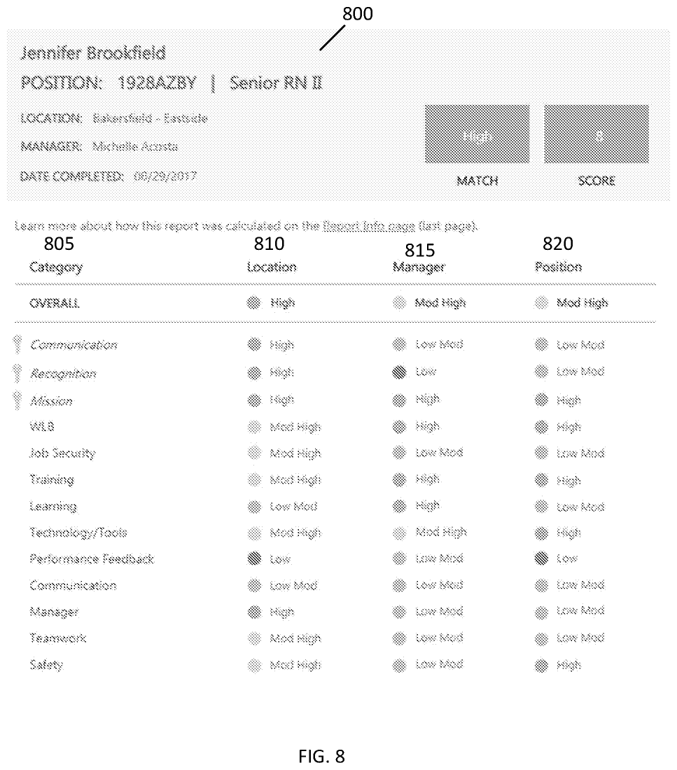

FIG. 8 is an illustration of a report 800 for a particular candidate, in accordance with principles of the disclosure. In this example, resulting scoring for “Jennifer Brookfield” is shown, which may be color coded, for each survey question (shown in column 805), by “location” (shown in column 810), and for the positon (in this example for position “Senior RN II, and as shown in column 820).

The system and process herein provides an assessment tool that leverages organizational employee survey data to depict an accurate representation pf an organization's culture versus recruiter/manager knowledge or anecdotal accounts of culture. The disclosure herein builds profiles of the culture environment for the role (or position), manager and organization based on real response from incumbent employees (i.e., by using their responses from organization's employee opinion survey). This permits an organization to build three different profiles and asses it at three different levels, i.e., the role, by manger, and by organization overall. In the past, misaligned expectations occur when companies rely solely on a high-level organizational structural culture vision statement, or comments from an on-line source. The techniques of this disclosure provides a more refined approach to evaluating potential new employees using three distinct levels of fit.

As the organization administers new employee opinion surveys, the latest data is utilized in the matching process to ensure best accuracy. Further, the approach herein allows for machine learning whereas more hires occur, the matching algorithm becomes more customized with better weighting to reflect what truly matters to an organization and what drives a culture. The process may also be used to move a culture over time to another direction. The constant addition of new hiring data permits more accurate and more valid results against what organizational leaders are looking towards. The techniques herein provide a tool that leverages actual incumbent data to evaluate a cultural profile of the organization.

The on-line reporting is user-friendly and quickly relays high-level “fit” scores that permit a manager to easily compare candidates to other candidates as well as compare one candidate to multiple job openings. In addition to the high-level “fit” score, the system provides each individual candidate a comparison point for detail-oriented managers as well as customized follow-up interview questions based on areas that candidates was not a good “fit.” The system and process herein also activates a structured interview guide and training videos for a hiring manager (or even candidate) to use during candidate interviews to further probe on important factors.

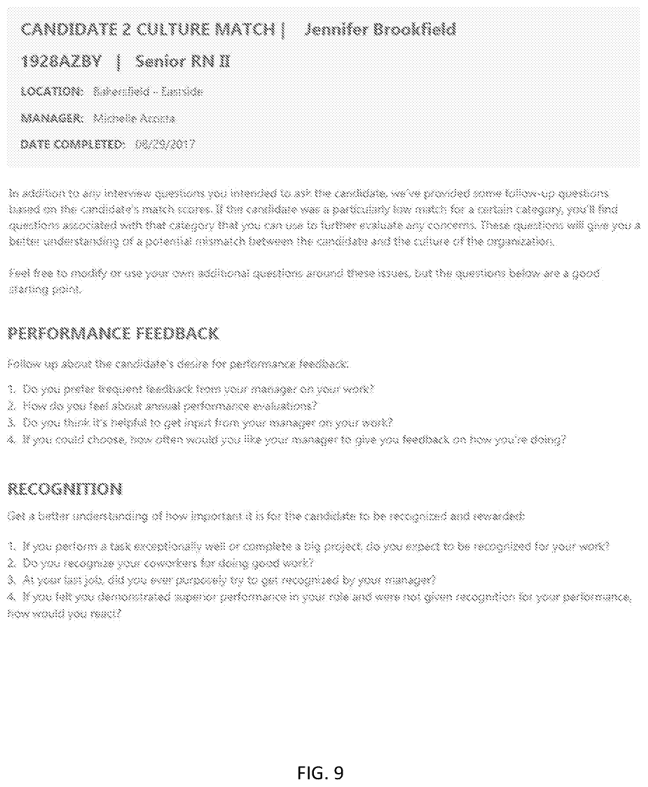

FIG. 9 is an exemplary structured interview questionnaire form that may be send to a hiring manager or interviewer in response to a request, or automatically in response to a mismatch. The exemplary form of FIG. 9 might be send if the process describes herein indicates a mismatch on questions relating to performance feedback or the importance of recognition. In such a case, the interviewer is directed to probe the candidate's interest in these themes with specific questions so that more data on fit between the candidate and the organization's culture may be developed. A structured interview may be indicated in cases where ESAD from specific questions has been aggregated into a theme like “feedback”, and the candidate has failed to match on that theme. In such cases, certain embodiments can provide the candidate with specific questions that correspond to the specific employee questions relating to the feedback theme, so as to get a sense as which particular areas of the more general “feedback” subject area are generating the mismatch.

The system and processes herein can assess candidates to uncover which characteristics of a job (e.g., career development, work-life balance) are most important to them. This enables an organization to understand what candidates really want that would keep them at the organization for a longer time. An organization can ascertain a “match” of the candidate's preference at the role, manager and organization level. For example, a manager can determine how a candidate's preferences align or match with the presence of various attributes like career development support, work-life balance, performance feedback, teamwork, etc. This allows an organization to score candidates on fit at each of the three levels, as well as an overall score. Hiring candidates who are a best fit for their job roles is a significant factor for reducing voluntary turnover and producing happier and more productive employees.

In the past, fit was typically assed in an unstructured interview or personality test. Interviews can be ineffective because it relies on one point of view or the organization from the interviewer point of view. Personality tests does not assess what candidates want in a culture. The system and process herein provides a much improved technique in hiring employees.

The systems, methods, and apparatus may include a “communication link,” which as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, OG, 1G, 2G, 3G, 4G or 5G cellular standards, Bluetooth, and the like. One or more communication links may be used in an environment 100 (shown in FIG. 1) to allow sufficient data throughput and interaction between end-users (such as, e.g., agents, consumers, insurance carriers, estate planners, financial providers, web host providers, and the like). Techniques for implementing such communications links are known to those of ordinary skilled in the art.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be m continuous communication with each other, unless expressly specified otherwise. In addition, devices that are in communication with each other may communicate directly or indirectly through one or more intermediaries.

Although process steps, method steps, algorithms, or the like, may be described m a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be perfomled simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The systems, methods, and apparatus may include a “computer-readable medium,” which as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, non-transitory storage mediums, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, OG, 1G, 2G, 3G, 4G or 5G cellular standards, Bluetooth, or the like.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A computer-implemented method for predicting employment candidate longevity, comprising, executing on a processor, the steps of:
receiving numerical response data generated in response to employee survey questions asked of existing employees in an organization;
selecting a plurality of employee survey questions, and for those questions averaging the corresponding numerical response data from a plurality of surveyed employees;
providing survey questions to an employment candidate, the survey questions corresponding to the plurality of selected employee questions, and receiving numerical responses to the provided survey questions from the employment candidate;
comparing the averaged numerical response data corresponding to the selected employee survey questions to the numerical responses of the candidate to the corresponding provided questions;
on the basis of the comparison, determining a degree of match between the averaged numerical response data corresponding to the selected employee survey questions to the numerical responses of the candidate to the corresponding provided questions, for each question, resulting in array of question match data;
applying a scale factor to one or more values in the array of question match data, the scale factor reflecting a degree of correlation between a corresponding employee survey question and employee longevity;
aggregating the scaled values in the array of question match data to result in a match score.

2. The method of claim 1, wherein applying a scale factor to one or more values in the array of question match data, the scale factor reflecting a degree of correlation between a corresponding employee survey question and employee longevity comprises performing a regression analysis on the numerical response data generated in response to employee survey questions against employee longevity to determine the extent to which each selected employee question is correlated with employee longevity.

3. The method of claim 1, further including the step of categorizing the numerical response data generated in response to employee survey questions into one or more profiles containing the numerical response data furnished by employees sharing a common characteristic.

4. The method of claim 3, wherein the common characteristic includes an employee's workplace location.

5. The method of claim 3, wherein the common characteristic includes an employee's supervisor's identity.

6. The method of claim 3, wherein the common characteristic includes a job role.

7. The method of claim 3, wherein aggregating the scaled values in the array of question match data to result in a match score comprises generating a match score for the one or more profiles.

8. The method of claim 7, further the comprising aggregating a match score for the one or more profiles to create an overall match score.

9. The method of claim 1, further comprising electronically transmitting the match score to a second computer having a processor and displaying the match score on a display.

10. The method of claim 9, wherein the match score is associated with a color indicating the value of the match score.

11. The method of claim 1, further including the step of recoding the received employee response data or the received candidate data.

12. The method of claim 1, further including the step of electronically transmitting a structured interview form including interview questions related to one or more topics on which there is mismatch between employee survey response data and candidate response data.

13. A non-transitory computer-readable medium for providing a method of predicting employment candidate longevity, comprising instructions stored thereon, that when executed on a processor, perform the steps of:
receiving numerical response data generated in response to employee survey questions asked of existing employees in an organization;
selecting a plurality of employee survey questions, and for those questions averaging the corresponding numerical response data from a plurality of surveyed employees;
receiving numerical responses to survey questions provided to a an employment candidate, the questions provided to the employment candidate corresponding to the selected plurality of employee survey questions;
comparing the averaged numerical response data corresponding to the selected employee survey questions to the numerical responses of the candidate to the corresponding questions;
on the basis of the comparison, determining a degree of match between the averaged numerical response data corresponding to the selected employee survey questions to the numerical responses of the candidate to the corresponding questions, for each question, resulting in array of question match data;
applying a scale factor to one or more values in the array of question match data, the scale factor reflecting a degree of correlation between a corresponding employee survey question and employee longevity;
aggregating the scaled values in the array of question match data to result in a match score.

14. The computer readable medium of claim 13, wherein applying a scale factor to one or more values in the array of question match data, the scale factor reflecting a degree of correlation between a corresponding employee survey question and employee longevity comprises performing a regression analysis on the numerical response data generated in response to employee survey questions against employee longevity to determine the extent to which each selected employee question is correlated with employee longevity.

15. The computer readable medium of claim 13, further comprising instructions stored thereon, that when executed on a processor, perform the steps of categorizing the numerical response data generated in response to employee survey questions into one or more profiles containing the numerical response data furnished by employees sharing a common characteristic.

16. The computer readable medium of claim 15, wherein the common characteristic includes an employee's workplace location.

17. The computer readable medium of claim 15, wherein the common characteristic includes an employee's supervisor's identity.

18. The computer readable medium of claim 15, wherein the common characteristic includes a job role.

19. The computer readable medium of claim 13, further comprising instructions stored thereon, that when executed on a processor, perform the step of aggregating the scaled values in the array of question match data to result in a match score comprises generating a match score for the one or more profiles.

20. The computer readable medium of claim 13, further comprising instructions stored thereon, that when executed on a processor, perform the step of electronically transmitting a structured interview form including interview questions related to one or more topics on which there is mismatch between employee survey response data and candidate response data.
